(19) United States
(12) Patent Application Publication
(10) Pub. No.: US 2010/0209630 A1
(43) Pub. Date: Aug. 19, 2010

(54) OPTICAL FILM, POLARIZER FILM AND IMAGE DISPLAY DEVICE

(76) Inventors: Kazuaki Watanabe, Tokyo (JP); Takatoshi Yosomiya, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/738,731

(22) PCT Filed: Oct. 16, 2008
(86) PCT No.: PCT/JP2008/068769

§ 371 Date: Apr. 19, 2010

(30) Foreign Application Priority Data
Oct. 19, 2007 (JP) 2007-272743
Dec. 17, 2007 (JP) 2007-325203
Mar. 24, 2008 (JP) 2008-076262
Mar. 24, 2008 (JP) 2008-076266

(51) Int. Cl. G02F 1/1335; C09K 19/52; C08K 5/3475

(52) U.S. Cl. 428/1.31; 524/91

(57) ABSTRACT

Such an optical film is provided that has excellent optical characteristics, such as small haze, excellent transparency, high visible light transmittance and low birefringence, is excellent in water vapor transmission rate, and has excellent ultraviolet ray absorbing capability, and a polarizer film using the optical film and an image display device using the polarizer film are provided.

The optical film for a protective film for a polarizer, contains a polypropylene resin mixture containing, as a major component, a polypropylene resin synthesized with a metallocene catalyst, having a benzotriazole compound added thereto, and a content of the benzotriazole compound is from 0.08 to 5.5% by mass based on the polypropylene resin mixture. The polarizer film has the optical film provided on at least one surface of a polarizer, and the image display device contains the polarizer film.

### TECHNICAL FIELD

The present invention relates to such an optical film for a protective film for a polarizer that has excellent optical characteristics, such as small haze, excellent transparency, high visible light transmittance and low birefringence, has good mechanical strength, heat resistance and water vapor transmission rate, and has excellent ultraviolet ray absorbing capability, a polarizer film having the film as a protective film on one surface or both surfaces of a polarizer, and an image display device using the polarizer film.

### BACKGROUND ART

A polarizer film is a material that has a function of transmitting only light that has a specific oscillation direction but blocking the other light, and is widely used, for example, as one of components constituting a liquid crystal display device. The polarizer film that is generally used has a laminate structure containing a polarizer and a protective film. The polarizer has a function of transmitting only light that has a specific oscillation direction, and, for example, a polyvinyl alcohol (which may be hereinafter referred to as “PVA”) film stretched and colored with iodine, a dichroic dye or the like is generally used therefor. In recent years, a coating type polarizer has been used.

The protective film has a function of, for example, holding the polarizer and imparting a practicable strength to the whole polarizer film, and, for example, a cellulose film, such as a cellulose triacetate (which may be hereinafter referred to as “TAC” or “CTA”) film is generally used therefor. A cellulose film exhibits excellent characteristics as a protective film for a polarizer owing to excellent optical homogeneity including high transparency and low birefringence, practical heat resistance, and excellent mechanical strength.

Furthermore, the cellulose film has good workability, such as high moisture transmission of PVA or an adhesive upon laminating with a polarizer of PVA or the like, and thus it is generally used as a protective film for a polarizer (see, for example, Patent Document 1).

However, the cellulose film (such as a TAC film) has problems of deteriorating the capability of the polarizer and exhibiting poor dimensional stability on absorbing water, due to the high water absorbability of the film.

For solving the problems, such an attempt has been made that the dimensional stability is enhanced by using a film material having a smaller water absorption rate than that of a conventional TAC film as a protective film for a polarizer. However, a polycarbonate film and a polyethyleneterephthalate film having small water absorbability have a large photoelastic constant and may suffer fluctuation in phase difference due to action of an external stress, and thus involves a problem of decrease in capability as a polarizer film.

Under the circumstances, a uniaxially stretched high density polyethylene or polypropylene film having low water vapor transmission rate as a film itself is proposed as a protective film for a polarizer (see, for example, Patent Document 2).

However, the uniaxially stretched polyethylene or polypropylene film has a problem that phase difference occurs to provide deterioration in capability as a polarizer film.

[Patent Document 1] JP-A-7-120617

[Patent Document 2] JP-B-6-12362

### BRIEF DESCRIPTION OF THE DRAWINGS

FIG. 1 The figure is a schematic view showing a process of producing a polarizer film of the present invention.

FIG. 2 The figure is a schematic view showing an example of a structure of a liquid crystal cell having a polarizer film of the present invention.

FIG. 3 The figure is a schematic view showing an example of a structure of a resistance film type touch-sensitive panel (glass-glass type) having a polarizer film of the present invention.

FIG. 4 The figure is a schematic view showing an example of a structure of a resistance film type touch-sensitive panel (glass-film type) having a polarizer film of the present invention.

### DESCRIPTION OF SYMBOLS

1 molten resin (PP)
2 optical device
3 polarizer
4 protective film (optical film)
5 adhesive layer
6 liquid crystal cell
7 polarizer film
8 retardation film (birefringence layer)
9 polarizer film of touch-sensitive panel
10 antireflection film
γ/4 plate
12 protective film for polarizer (upper side)
12′ protective film for polarizer (lower side)
13 polarizer (PVA)
14 glass
15 ITO protective film
16 protective film for polarizer (lower outer side)
17 polarizer film of touch-sensitive panel

### DISCLOSURE OF THE INVENTION

### Problems to be Solved by the Invention

In view of the problems, the inventors have developed a polypropylene resin synthesized with a metallocene catalyst as a resin used for an optical film (see, for example, Patent Application No. 2007-261295). The polypropylene resin synthesized with a metallocene catalyst has excellent optical characteristics, such as small haze, excellent transparency, high visible light transmittance and low birefringence, and good mechanical strength, heat resistance and water vapor transmission rate, but is insufficient in ultraviolet ray absorbing capability, which is demanded to be further enhanced.

An organic member, such as a polarizer, is generally provided with an ultraviolet ray protective filter or protected with a protective film containing an ultraviolet ray absorbent, for preventing deterioration by an ultraviolet ray. Examples of the ultraviolet ray absorbent used in the protective film generally include, for example, for a TAC film, various kinds of compounds including an oxybenzophenone compound, a benzotriazole compound, a salicylate ester compound, a benzophenone compound, a cyanoacrylate compound and a nickel complex salt compound.

In the case where the ultraviolet ray absorbent is applied to an optical film containing a polypropylene resin as a major component, however, such problems occur that (i) bleeding out, such as oozing to the surface of the film, of the ultraviolet ray absorbent lowers the stability upon forming the film, (ii) the amount of the ultraviolet ray absorbent used is increased for ensuring the ultraviolet ray absorbing capability since the ultraviolet ray absorbent disappears due to evaporation or the like upon forming, (iii) the ultraviolet ray absorbing capability is too low as compared to the addition amount thereof, and the like, and thus there are restrictions in kind of the ultraviolet ray absorbents that can be applied thereto. Furthermore, the ultraviolet ray absorbent that can be applied thereto may vary depending on the kind of the polypropylene resin. Accordingly, such an ultraviolet ray absorbent is demanded to be studied that can be applied to an optical film containing, as a major component, a polypropylene resin synthesized with a metallocene catalyst used in the invention.

An object of the invention is to provide such an optical film for a protective film for a polarizer that has excellent optical characteristics, such as small haze, excellent transparency, high visible light transmittance and low birefringence, has good mechanical strength, heat resistance and water vapor transmission rate, and has excellent ultraviolet ray absorbing capability, a polarizer film having the film as a protective film on one surface or both surfaces of a polarizer, and an image display device using the polarizer film.

### Means for Solving the Problems

As a result of earnest investigations made by the inventor for solving the problems, it has been found that an optical film containing, as a major component, a polypropylene resin synthesized with a metallocene catalyst, having a benzotriazole compound added thereto is suitable as a protective film for a polarizer, and solves the problems.

Specifically, the present invention relates to the following.

(1) An optical film for a protective film for a polarizer, containing a polypropylene resin mixture containing, as a major component, a polypropylene resin synthesized with a metallocene catalyst, having a benzotriazole compound added thereto, a content of the benzotriazole compound being from 0.08 to 5.5% by mass based on the polypropylene resin mixture.

(2) The optical film according to the item (1), wherein the polypropylene resin has a bending elastic modulus of 700 MPa or more.

(3) The optical film according to the item (1) or (2), wherein the polypropylene resin has a melt flow rate (MFR: measured under conditions of 230° C. and a load of 2.16 kg according to JIS K7210) of 20 g per 10 minutes or more.

(4) The optical film according to one of the items (1) to (3), wherein the benzotriazole compound is a benzotriazole phenol compound.

(5) The optical film according to the item (4), wherein the benzotriazole phenol compound is 2-(2H-benzotriazol-2-yl)-4-(1,1,3,3-tetramethylbutyl)pheno 1 or 2-(2H-benzotriazol-2-yl)-4,6-di-tert-pentylphenol.

(6) The optical film according to one of the items (1) to (5), wherein the optical film is an unstretched film.

(7) A polarizer film containing the optical film according to one of the items (1) to (6) provided on at least one surface of a polarizer.

(8) The polarizer film according to the item (7), wherein the polarizer film is used by adhering to a liquid crystal cell, and the optical film is provided on a side of the polarizer opposite to the liquid crystal cell.

(9) An image display device containing the polarizer film according to the item (7) or (8). An optical film for a protective film for a polarizer, containing a polypropylene resin synthesized with a metallocene catalyst.

### ADVANTAGES OF THE INVENTION

The optical film of the present invention has excellent optical characteristics, such as small haze, excellent transparency, high visible light transmittance and low birefringence, is excellent in water vapor transmission rate, and has excellent ultraviolet ray absorbing capability. Furthermore, the optical film is excellent in various durability, such as heat resistance and wet heat resistance, may enhance the polarization degree of a polarizer film without influence on the optical function of the polarizer film, and is flexible and rich in elasticity. Moreover, the optical film of the present invention has resistance to external impact and deformation, and therefore, by laminating the optical film to a polarizer, such a polarizer film is provided that is capable of significantly enhancing the strength and the reliability of a liquid crystal display device.

In addition, as compared to a TAC film having been generally used, the optical film of the present invention has a protection function that is equivalent to or better than that of a TAC film. In particular, a TAC film is hydrophilic and has little moisture blocking property, but the optical film of the present invention is hydrophobic and therefore can greatly enhance durability of a polarizer film.

### Best Mode for carrying out the Invention

### Polypropylene Resin synthesized with Metallocene Catalyst

The optical film of the present invention contains a polypropylene resin mixture containing, as a major component, a polypropylene resin synthesized with a metallocene catalyst, to which a benzotriazole compound is added.

The polypropylene resin used in the present invention is one synthesized with a metallocene catalyst described later, and is preferably a copolymer of propylene and an α-olefin. Examples of the α-olefin includes ethylene and a 1-olefin having from 4 to 18 carbon atoms, and more specifically ethylene, 1-butene, 1-pentene, 1-hexene, 1-octene, 1-heptene, 4-methyl-pentene-1,4-methyl-hexene-1 and 4,4-dimethylpentene-1. The proportion of the propylene unit in the copolymer is preferably 80% by mol or more, and the proportion of the comonomer is preferably 20% by mol or less. The comonomer is not limited to one kind of the aforementioned α-olefin, but two or more kinds thereof may be used to provide a multi-component copolymer, such as a terpolymer.

The metallocene catalyst used in the present invention may be a single-site catalyst having active sites dispersed homogeneously, or a multi-site catalyst having active sites dispersed inhomogeneously, and among these, a multi-site catalyst is preferred. Examples of the catalyst generally used include a Group 4 to 6 transition metal compound, such as Zr, Ti and Hf, particularly a Group 4 transition metal compound, and an organic transition metal compound having a cyclopentadienyl group or a group derived from a cyclopentadienyl derivative.

Examples of the group derived from a cyclopentadienyl derivative include an alkyl-substituted group, such as pentamethylcyclopentadienyl, and a group constituting a saturated or unsaturated cyclic substituent group by bonding two or more substituents, and representative examples thereof include an indenyl group, a fluorenyl group, an azulenyl group, and partially-hydrogenated groups thereof. Preferred examples thereof also include groups containing plural cyclopentadienyl groups bonded through an alkylene group, a silylene group, a germylene group or the like.

Examples of a co-catalyst that can be used include at least one compound selected from a group consisting of an aluminiumoxy compound, an ionic compound capable of reacting with a metallocene compound to convert the metallocene compound component into a cation, a Lewis acid, a solid acid and an ion-exchangeable layered silicate salt. An organoaluminum compound may be added along with those compounds depending on necessity.

The layered silicate salt is a silicate salt compound having a crystal structure, in which the constitutive layers are accumulated in parallel to each other with a weak bonding force, such as an ionic bond. In the present invention, the layered silicate salt is preferably ion-exchangeable. The ion-exchangeable property referred herein means that the interlayer cation of the layered silicate salt is exchangeable. Most layered silicate salts as natural products are produced essentially as a main ingredient of clay minerals, and the layered silicate salt used herein is not limited to the naturally produced ones but may be synthetic ones.

Specific examples of the layered silicate salt include known layered silicate salts without particular limitation, for example, include a kaolin mineral, such as dickite, nacrite, kaolinite, anauxite, metahalloysite and halloysite; a surpentine mineral, such as chrysotile, lizardite and antigorite; a smectite mineral, such as montmorillonite, zaukonite, viderite, nontronite, saponite, tainiolite, hectorite and stevensite; a vermiculite mineral, such as vermiculite; a mica mineral, such as mica, illite, sericite and glauconite; attapulgite; sepiolite; palygorskite; bentonite; pyrophyllite; talc; and a chlorite mineral. These may form a mixed layer.

Among these, a smectite mineral, such as montmorillonite, zaukonite, viderite, nontronite, saponite, hectorite, stevensite, bentonite and tainiolite; a vermiculite mineral; and a mica mineral are preferred.

The layered silicates may be chemically treated. The chemical treatment herein may be any of a surface treatment that removes impurities attached to the surface, or a treatment that makes influences on the crystalline structure and the chemical composition of the layered silicate. Specific examples of the treatment include (a) an acid treatment, (b) an alkali treatment, (c) a salt treatment, and (d) an organic substance treatment. The treatment removes impurities from the surface, exchanges the interlayer cation, or elutes the cation, such as Al, Fe and Mg, in the crystalline structure, thereby forming an ionic complex, a molecular complex, an organic derivative or the like, which changes the surface area, the interlayer distance, the solid acidity or the like. The treatment may be performed solely, or two or more of the treatments may be combined.

Examples of the method of synthesizing a polypropylene resin with the metallocene catalyst (polymerization method) include a slurry method using an inert solvent in the presence of the catalyst, a gas phase method using substantially no solvent, a solution method, and a bulk polymerization method using the polymerizable monomer as a solvent.

### Bending Elastic Modulus

The polypropylene resin in the present invention preferably has a bending elastic modulus of 700 MPa or more, and more preferably 900 MPa or more. In the case where the resin has a bending elastic modulus within the range, the optical film has a sufficient strength, which facilitates post processing.

### Melt Flow Rate

The polypropylene resin in the present invention preferably has a melt flow rate (which may be hereinafter referred to as MFR) of 20 g per 10 minutes or more, and more preferably from 20 to 40 g per 10 minutes. The MFR is a value measured according to JIS K7210, and the measurement conditions therefor are 230° C. and a load of 2.16 kg. In the case where the polypropylene resin has an MFR within the range, the optical film has a sufficient strength, which facilitates post processing. In the case where the polypropylene resin has an MFR within the range, the resin hardly suffers distortion and thus hardly exhibits phase difference. Furthermore, the MFR can be easily stabilized within the production lot to enable stable molding, and thus the amount of an additive added, such as an MFR controlling agent, can be reduced, thereby eliminating adverse affects on the properties. The MFR of the polypropylene resin can be controlled with an ordinary MFR controlling agent, such as an organic peroxide.

### Other Properties

The polypropylene resin in the present invention preferably has a melting point (Tm) of 130° C. or more. In the case where the resin has a melting point (Tm) of 130° C. or more, the optical film favorably enhanced in heat resistance, and the polarizer film can be applied to such purpose that requires heat resistance.

The polypropylene resin preferably has a tensile strength of 20 MPa or more. In the case where the tensile strength is 20 MPa or more, the optical film does not suffer orientation upon laminating the film with a polarizer through an adhesive layer by a roll-to-roll method, and thus the optical film does not exhibit phase difference to maintain the capability of the polarizer film.

### Benzotriazole Compound

The polypropylene resin mixture used in the optical film of the present invention contains a benzotriazole compound, and the content thereof is from 0.08 to 5.5% by mass based on the resin mixture. The benzotriazole compound is used as an ultraviolet ray absorbent and imparts ultraviolet ray absorbing capability to the optical film of the present invention.

In general, the light energy of an ultraviolet ray is classified into, in the order of from the longer wavelength, UV-A (380 to 315 nm), UV-B (315 to 280 nm) and UV-C (280 to 100 nm). While the optical film is largely damaged with a shorter wavelength, the amount of an ultraviolet ray having a wavelength of 280 nm or less that reaches the earth surface is small since sunlight having a shorter wavelength is absorbed by the ozone layer or oxygen in the air. Most of the deterioration of a polypropylene resin occurs due to radiation of light having a wavelength of from 280 to 400 nm, and it has been known that the major absorption wavelength of a polypropylene resin is 310 nm (UV-B range), 330 nm (UV-A range) and 370 nm (UV-A range). For preventing a polypropylene resin from being deteriorated due to an ultraviolet ray, accordingly, it is necessary to absorb light in the UV-A range and the UV-B range with the ultraviolet ray absorbent added. The benzotriazole compound added to the optical film of the present invention is preferably one that absorbs particularly light in the UV-A range and the UV-B range. In the case where an inorganic ultraviolet absorbing metallic oxide that absorbs light in the ranges is used, such advantages are favorably obtained that deterioration of the polarizer or deterioration of the liquid crystal described later can also be prevented.

The optical film of the present invention contains a benzotriazole compound as an ultraviolet ray absorbent.

Examples of the benzotriazole compound used in the optical film of the present invention include a benzotriazole phenol compound, such as 2-(2H-benzotriazol-2-yl)-4-(1,1,3,3-tetramethyl)phenol, 2-(2H-benzotriazol-2-yl)-4,6-di-tert-pentylphenol, 2-(2H-benzotriazol-2-yl)-4,6-bis(1-methyl-1-phenylethyl)-phenol, 2-(2H-benzotriazol-2-yl)-4-(1,1,3,3-tetramethylbutyl)-phenol, 2-(2H-benzotriazol-2-yl)-p-cresol, 2,2′-methylene-bis(6-(2H-benzotriazol-2-yl)-4-(1,1,3,3-tetramethylbutyl)-phenol) and 2-(5-chloro-2H-benzotriazol-2-yl)-4-methyl-6-tert-butyl-phenol, 2-(2-hydroxy-3,5-di-tert-butyl-phenyl)-5-chloro-2H-benzotriazole, 2-(2-hydroxy-3,5-di-tert-pentylphenyl)-2H-benzotriazole, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-amylphenyl)benzotriazole, 2-(2′-hydroxy-3′,5′-di-tert-butylphenyl)-5-chloro-benzotriazole, 2-(2′-hydroxy-3′-(3″,4″,5″,6″-tetrahydrophthalimide-methyl)-5′-methylphenyl)benzotriazole, 2-(2′-hydroxy-3′-tert-butyl-5′-methylphenyl)-5-chloro-benzotriazole, 2-(2′-hydroxy-3′,5′-di-tert-amylphenyl)-5-chloro-benzotriazole, 3-(3-(benzotriazol-2-yl)-5-tert-butyl-4-hydroxyphenyl)-propionate ester of polyethylene glycol, 2-(2′-hydroxy-5′-tert-butylphenyl)benzotriazole, 2-(2′-hydroxy-3′-tert-butyl-5′-methylphenyl)-5-chloro-benzotriazole, 2-(2′-hydroxy-5′-isooctylphenyl)-benzotriazole, 2-(2′-hydroxy-5′-n-octylphenyl)-benzotriazole, 2-(2′-hydroxy-5′-dodecylphenyl)-benzotriazole, 2-(2′-hydroxy-5′-hexadecylphenyl)-benzotriazole and 2-(2′-hydroxy-3′-tert-amyl-5′-benzophenyl)-benzotriazole.

Among these, a benzotriazole phenol compound, such as 2-(2H-benzotriazol-2-yl)-4,6-bis(1-methyl-1-phenylethyl)-phenol, 2-(2H-benzotriazol-2-yl)-4-(1,1,3,3-tetramethylbutyl)-phen ol, 2-(2H-benzotriazol-2-yl)-p-cresol, 2,2′-methylene-bis(6-(2H-benzotriazol-2-yl)-4-(1,1,3,3-tetramethylbutyl)-phenol) and 2-(5-chloro-2H-benzotriazol-2-yl)-4-methyl-6-tert-butyl-phenol, 2-(2-hydroxy-3,5-di-tert-butyl-phenyl)-5-chloro-2H-benzotriazole, 2-(2-hydroxy-3,5-di-tert-pentylphenyl)-2H-benzotriazole, 2-(2′-hydroxy-3′,5′-di-tert-butylphenyl)-5-chloro-benzotriazole and 2-(2′-hydroxy-3′,5′-di-tert-amylphenyl)-5-chloro-benzotriazole are preferred, and the benzotriazole phenol compounds mentioned above are more preferred from the standpoint of stability of the ultraviolet ray absorbing capability. In particular, 2-(2H-benzotriazol-2-yl)-4-(1,1,3,3-tetramethylbutyl)-phenol and 2-(2H-benzotriazol-2-yl)-4,6-di-tert-pentylphenol are preferred from the standpoint of less bleeding out after production of the optical film and stability of the ultraviolet ray absorbing capability.

The content of the benzotriazole compound is necessarily from 0.08 to 5.5% by mass, and preferably from 0.5 to 1.5% by mass, based on the polypropylene resin mixture. In the case where the content of the benzotriazole compound is in the range, the optical film of the present invention is imparted with favorable ultraviolet ray absorbing capability, and the film ensures favorable transparency, causes no coloration and suffers no bleeding out after production of the optical film. The benzotriazole compound may be used solely or as a mixture of two or more kinds thereof in an arbitrary ratio.

### Metallic Oxide Ultraviolet Ray Absorbent

The polypropylene resin mixture in the present invention may further contain a metallic oxide ultraviolet ray absorbent in addition to the aforementioned benzotriazole compound as an organic ultraviolet ray absorbent. Preferred examples of the metallic oxide ultraviolet ray absorbent include zinc oxide, titanium oxide, cerium oxide and iron oxide, and among these, zinc oxide and titanium oxide are preferred. The ultraviolet ray absorbents may be used solely or as a mixture of two or more kinds thereof in an arbitrary ratio.

The average particle diameter of the metallic oxide ultraviolet ray absorbent is preferably from 5 to 90 nm, and more preferably from 5 to 50 nm, from the standpoint of ensuring the ultraviolet ray absorbing capability while maintaining favorable visible light transmittance. The average particle diameter of the ultraviolet ray absorbing metallic oxide is preferably as small as possible from the aforementioned viewpoint, but taking the production cost into consideration, the lower limit thereof is 5 nm. The average particle diameter herein is obtained in the following manner. A dispersion liquid containing carbon black having been sufficiently diluted and dispersed in a solvent, such as chloroform, is spread and dried on a mesh with a collodion membrane. A transmission electron micrograph thereof is taken with a transmission electron microscope (TEM) and then subjected to computer image analysis. The diameter of the circle having an area that is equal to the area of the aggregate thus extracted by the analysis (i.e., the equiareal circle diameter) is designated as the particle diameter, and the arithmetic average obtained from the resulting particle diameter distribution is designated as the average particle diameter.

The content of the metallic oxide ultraviolet ray absorbent is generally approximately from 0.08 to 5.5% by mass based on the polypropylene resin mixture for providing favorable transparency while maintaining the favorable ultraviolet ray absorbing capability of the optical film.

As the raw material of the metallic oxide ultraviolet ray absorbent, a powder material may generally be used. In the case where the metallic oxide ultraviolet ray absorbent is in the form of powder, the metallic oxide ultraviolet ray absorbent is poor in dispersibility, and therefore, it is necessary to prepare a master batch of the polypropylene resin and the metallic oxide ultraviolet ray absorbent, which is then kneaded with the polypropylene resin. The content of the metallic oxide ultraviolet ray absorbent upon preparing the master batch is preferably 50% by mass or less, and more preferably 20% by mass or less, based on the mixture of the polypropylene resin and the metallic oxide ultraviolet ray absorbent. In the case where the content of the metallic oxide ultraviolet ray absorbent is in the range, favorable dispersibility of the metallic oxide ultraviolet ray absorbent in the master batch is obtained.

### Sorbitol Additive

In the present invention, a sorbitol additive may be contained in the polypropylene resin mixture for enhancing the tensile strength and enhancing the transparency. As the sorbitol additive, a dibenzylidene sorbitol additive less affecting the phase difference is preferred.

Preferred examples of the dibenzylidene sorbitol additive include a di-substituted dibenzylidene sorbitol, such as 1,3-2,4-dibenzylidene sorbitol and 1,3-2,4-di-p-methylbenzylidene sorbitol, and a mixture of a di-substituted benzylidene sorbitol and a diglycerin monofatty acid ester.

It has been known that the dibenzylidene sorbitol additive contributes to enhancement of the transparency and enhancement of the strength of the polypropylene resin, as a clearing nucleating agent, and it has been found in the present invention that in the case where the additive is used in the optical film for a protective film for a polarizer, it has little influence on the phase difference thereof.

In the dibenzylidene sorbitol additives, a diglycerin monofatty acid ester-added dibenzylidene sorbitol nucleating agent is preferred since it exhibits less bleeding out and is stable. Preferred examples of the diglycerin monofatty acid ester include diglycerin monolaurate ester, diglycerin monomyristate ester and diglycerin monostearate ester, which may be used solely or as a mixture thereof.

The content of the additive is preferably from 0.03 to 0.5% by mass, and preferably from 0.05 to 0.25% by mass, based on the polypropylene resin mixture. In the case where the content is 0.03 part by mass or more, the transparency and the strength can be sufficiently enhanced. In the case where the content is 0.5 part by mass or less, it is advantageous from cost since enhancement of the transparency and the strength can be obtained efficiently.

In the case where a di-substituted benzylidene sorbitol having a diglycerin monofatty acid ester added thereto is used, the amount of the di-substituted benzylidene sorbitol added is preferably from 0.03 to 0.3% by mass, and the amount of the diglycerin monofatty acid ester added is preferably from 0.01 to 0.2% by mass, both based on the polypropylene resin composition.

The dibenzylidene sorbitol additive and the benzotriazole compound are preferably used in the granulated form separately or after mixing them for the purpose of enhancing the dispersibility thereof in the polypropylene resin mixture. The granulation may be performed by such a method as melt extrusion granulation, dry extrusion granulation and compression granulation.

### Various Kinds of Olefin Resins and Additives

Various kinds of olefin resins and additives may be added to the optical film of the present invention depending on the desired properties of the resulting film in such a range that does not impair the required transparency.

Examples of the olefin resin include homopolypropylene and random polypropylene produced with a Ziegler catalyst, which may be mixed in a small amount not exceeding 10% by mass.

Examples of the additive include a weather resistance improving agent, an abrasion resistance enhancing agent, a polymerization inhibitor, a crosslinking agent, an infrared ray absorbent, an antistatic agent, an adhesiveness enhancing agent, a leveling agent, a thixotropy imparting agent, a coupling agent, a surfactant, a polyelectrolyte, an electroconductive complex, an antiblocking agent, a lubricant, a plasticizer, a defoaming agent, a filler and a solvent.

A light stabilizer may be used as the weather resistance improving agent.

A hindered amine light stabilizer (HALS) is preferred as the light stabilizer. The hindered amine light stabilizer (HALS) functions as a radical scavenger. Examples of the hindered amine light stabilizer (HALS) include N,N′,N″,N′″-tetrakis(4,6-bis(butyl(N-methyl-2,2,6,6-tetramethylpyperidin-4-yl)amino)triazin-2-yl)-4,7-diazadecane-1,10-diamine, a polycondensate of dibutylamine-1,3,5-triazine-N,N′-bis(2,2,6,6-tetramethyl-4-piperidyl-1,6-hexamethylene diamine and N-(2,2,6,6-tetramethyl-4-piperidyl)butylamine, poly((6-(1,1,3,3-tetramethylbutyl)amino-1,3,5-triazin-2,4-diyl)((2,2,6,6-tetramethyl-4-piperidyl)imino)-hexamethylene((2,2,6,6-tetramethyl-4-piperidyl)imino)), a polymer of dimethyl succinate and 4-hydroxy-2,2,6,6-tetramethyl-1-piperidineethanol, a reaction product of bis(2,2,6,6-tetramethyl-1-(octyloxy)-4-piperidinyl decanedioate ester, 1,1-dimethylethylhydroperoxide and octane, bis(1,2,2,6,6-pentamethyl-4-piperidyl)-((3,5-bis(1,1-dimethylethyl)-4-hydroxyphenyl)methyl)butyl malonate, a mixture of bis(1,2,2,6,6-pentamethyl-4-piperidyl)sebacate and methyl-1,2,2,6,6-pentamethyl-4-piperidyl sebacate, bis(2,2,6,6-pentamethyl-4-piperidyl)sebacate, bis(1,2,2,6,6-pentamethyl-4-piperidyl) 2-(3,5-di-tert-butyl-4-hydroxybenzyl)-2′-n-butylmalonate, bis(1,2,2,6,6-pentamethyl-4-piperidyl)sebacate and tetrakis(2,2,6,6-tetramethyl-4-piperidyl) 1,2,3,4-butanetetracarboxylate.

As the light stabilizer, a reactive compound having a polymerizable group, such as a (meth)acryloyl group, in the molecule may be used.

Examples of the abrasion resistance improving agent include an inorganic substance, such as spherical particles of α-alumina, silica, kaolinite, iron oxide, diamond and silicon carbide. The shape of the particles is not particularly limited, and examples thereof include a sphere, an ellipsoid, a polyhedron and a flake, and preferably a spherical shape. Examples of the abrasion resistance improving agent also include an organic substance, such as synthetic resin beads, e.g., a crosslinked acrylic resin and a polycarbonate resin. The particle diameter thereof may be generally approximately from 30 to 200% of the thickness of the optical film. Among these, spherical α-alumina is especially preferred since it has high hardness exhibiting large effect on enhancement of the abrasion resistance, and spherical particles thereof are easily provided.

Examples of the polymerization inhibitor include hydroquinone, p-benzoquinone, hydroquinone monomethyl ether, pyrogallol and t-butylcatechol, and examples of the crosslinking agent include a polyisocyanate compound, an epoxy compound, a metal chelate compound, an aziridine compound and an oxazoline compound.

Examples of the filler include barium sulfate, talc, clay, calcium carbonate and aluminum hydroxide.

Examples of the infrared ray absorbent include a dithiol metallic complex, a phthalocyanine compound and a diimmonium compound.

Various kinds of additives may be added to the optical film for imparting various functions thereto, for example, such a function may be imparted as a hardcoat function imparting scratch resistance with high hardness, an antifogging function, an antifouling function, an antiglare function, an antireflection function, an ultraviolet ray-blocking function and an infrared ray-blocking function.

Method for producing Optical Film

A method for producing the optical film of the present invention will be described below.

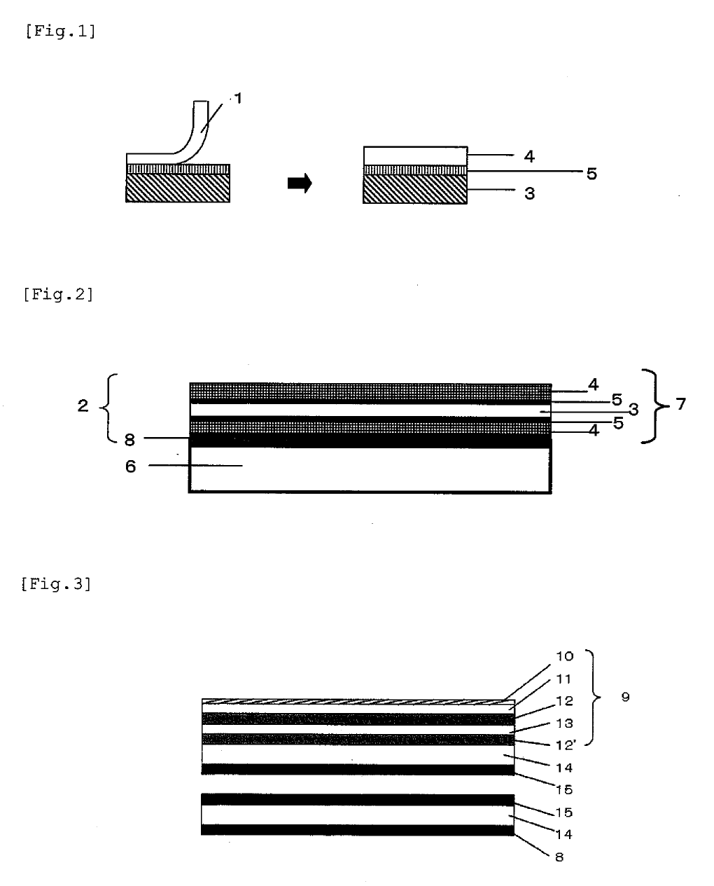

The optical film may be produced with the polypropylene resin directly on a polarizer by various forming methods, such as an extrusion coating forming method, a casting method, a T-die extrusion molding method, an inflation method and an injection molding method (see FIG. 1). In alternative, it is possible that the optical film 4 is formed according to any of the molding methods in advance, and then is laminated with a polarizer through an adhesive layer.

In the present invention, it is desired that the optical film to be formed on a polarizer is not oriented, and therefore, T-die extrusion molding is preferred since no stretching is applied thereby.

The thickness of the optical film is preferably in a range of from 10 to 200 μm, and more preferably from 30 to 150 μm. In the case where the thickness is 10 μm or more, the film may have a strength sufficient as a protective film for a polarizer, and in the case where the thickness is 200 μm or less, the film may have sufficient flexibility and may be lightweight, thereby facilitating the handling thereof and being advantageous in cost.

FIG. 1 shows a method of producing an optical film directly on a polarizer. In FIG. 1, an adhesive layer 5 is coated on a polarizer 3 in advance, and a polypropylene molten resin 1 is formed into a film by an extrusion method (left figure in FIG. 1). The polypropylene resin thus formed into a film is then solidified to provide a protective film 4.

In alternative, it is possible that the protective film 4 is produced by a T-dye method in advance, and then is adhered to a polarizer 3 having an adhesive layer 2 coated in advance.

### Polarizer Film

The polarizer film of the present invention contains a polarizer having adhered on one surface or both surfaces thereof the optical film of the present invention, and taking the cost in consideration, a polarizer film containing a polarizer having adhered on one surface thereof the optical film is preferred. The optical film is adhered to the polarizer and functions as a protective film. In the case where the polarizer film is used inside a liquid crystal display device without protection with the optical film, deterioration of the polarizer and the liquid crystal may occur due to external light and ultraviolet light from the back light. For preventing the deterioration from occurring, in the case where the polarizer film of the present invention is used by adhering to a liquid crystal cell inside a liquid crystal display device, while a polarizer film disposed on the outer light side in the liquid crystal display device is referred to as an upper side polarizer film, and a polarizer film disposed on the back light side therein is referred to as a lower side polarizer film, such an embodiment is preferred that the optical film of the present invention is adhered to one surface of the upper side polarizer film that is opposite to the liquid crystal cell and on one surface of the lower side polarizer film opposite to the liquid crystal cell.

The polarizer used in the polarizer film of the present invention may be any one having a function of transmitting only light that has a specific oscillation direction, and examples thereof include a polyvinyl alcohol polarizer formed by stretching a polyvinyl alcohol film or the like followed by dyeing it with iodine, a dichroic dye or the like; a polyene polarizer, such as a dehydrated product of polyvinyl alcohol or a dehydrochlorinated product of polyvinyl chloride; a reflection type polarizer using a cholesteric liquid crystal; and a thin crystal film polarizer. Among those, a polyvinyl alcohol polarizer is preferably used.

Examples of the polyvinyl alcohol polarizer include ones produced in such a manner that a dichroic substance, such as iodine and a dichroic dye, is adsorbed to a hydrophilic polymer film, such as a polyvinyl alcohol film, a partially formalized polyvinyl alcohol film and a partially saponified ethylene-vinyl acetate copolymer film, which is uniaxially stretched. Among these, a polarizer containing a polyvinyl alcohol film and a dichroic substance, such as iodine, is preferably used. The thickness of the polarizer is not particularly limited and may be generally approximately from 1 to 100 μm.

The PVA resin favorably used as a resin constituting the polarizer may be produced through saponification of a polyvinyl acetate resin. Examples of the polyvinyl acetate resin include polyvinyl acetate, which is a homopolymer of vinyl acetate, and also include a copolymer of vinyl acetate with another monomer copolymerizable therewith. Examples of the another monomer copolymerized with vinyl acetate include an unsaturated carboxylic acid, an olefin, a vinyl ether and an unsaturated sulfonic acid.

The degree of saponification of the PVA resin may be generally from 85 to 100 mol %, and preferably from 98 to 100 mol %. The PVA resin may be further modified, and for example, polyvinyl formal and polyvinyl acetal, which are modified with an aldehyde, may be used. The degree of polymerization of the PVA resin is generally from 1,000 to 10,000, and preferably from 1,500 to 10,000.

The polarizer film may be produced through a step of uniaxially stretching the PVA resin film, a step of dyeing the PVA resin film with a dichroic colorant, whereby the dichroic colorant is adsorbed thereto, a step of treating the PVA resin film having the dichroic colorant absorbed thereto with an aqueous boric acid solution, a step of rinsing after treatment with the aqueous boric acid solution, and a step of adhering a protective film to the uniaxially stretched PVA resin film having the dichroic colorant adsorbed thereon and having been oriented through the previous steps.

The uniaxial stretching may be performed before dyeing with the dichroic colorant, or simultaneously with dying with the dichroic colorant, or may be performed after dyeing with the dichroic colorant. In case where the uniaxial stretching is performed after dyeing with the dichroic colorant, the uniaxial stretching may be performed before the treatment with boric acid, or during the treatment with boric acid. The uniaxial stretching may be performed in the plural steps among these steps. For performing the uniaxial stretching, the film may be uniaxially stretched between rolls having peripheral speeds different from each other, or may be uniaxially stretched with a hot roll. It may be dry stretching performed in the air, or may be wet stretching of stretching the film in a swollen state with a solvent. The stretching ratio may be generally approximately from 4 to 8 times.

For dyeing the PVA resin film with the dichroic colorant, for example, the PVA resin film may be immersed in an aqueous solution of the dichroic colorant. Examples of the dichroic colorant used include iodine and a dichroic dye.

In the case where iodine is used as the dichroic colorant, such a method may be generally employed that the PVA resin film is dyed by immersing in an aqueous solution containing iodine and potassium iodide. The content of iodine in the aqueous solution is generally approximately from 0.01 to 0.5 parts by mass per 100 parts by mass of water, and the content of potassium iodide is generally approximately from 0.5 to 10 parts by mass per 100 parts by mass of water. The temperature of the aqueous solution is generally approximately from 20 to 40° C., and the immersing time in the aqueous solution is generally approximately from 30 to 300 seconds.

In case where a dichroic dye is used as the dichroic colorant, on the other hand, such a method may be generally employed that the PVA resin film is dyed by immersing in an aqueous solution containing a water-soluble dichroic dye. The content of the dichroic dye in the aqueous solution is generally approximately from 1×10⁻³ to 1×10⁻² parts by mass per 100 parts by mass of water. The aqueous solution may contain an inorganic salt, such as sodium sulfate. The temperature of the aqueous solution is generally approximately from 20 to 80° C., and the immersing time in the aqueous solution is generally approximately from 30 to 300 seconds.

The treatment with boric acid after dyeing with the dichroic colorant may be performed by immersing the dyed PVA resin film in an aqueous solution of boric acid. The content of boric acid in the aqueous boric acid solution is generally approximately from 2 to 15 parts by mass, and preferably from 5 to 12 parts by mass, per 100 parts by mass of water.

In case where iodine is used as the dichroic colorant, the aqueous boric acid solution preferably contains potassium iodide. The content of potassium iodide in the aqueous boric acid solution is generally approximately from 2 to 20 parts by mass, and preferably from 5 to 15 parts by mass, per 100 parts by mass of water. The immersing time in the aqueous boric acid solution is generally approximately from 100 to 1,200 seconds, preferably approximately from 150 to 600 seconds, and more preferably approximately from 200 to 400 seconds. The temperature of the aqueous boric acid solution is generally 50° C. or more, and preferably from 50 to 85° C.

After the treatment with boric acid, the PVA resin film is generally rinsed with water. The rinsing treatment with water may be performed, for example, by immersing the PVA resin film having been treated with boric acid in water. After rinsing with water, the film is dried to provide a polarizer. The temperature of water in the washing treatment with water is generally approximately from 5 to 40° C., and the immersing time is generally approximately from 2 to 120 seconds. The drying treatment performed thereafter is generally performed with a hot air drier or a far infrared heater. The drying temperature is generally from 40 to 100° C. The treating time for the drying treatment is generally approximately from 120 to 600 seconds.

According to the procedures, a polarizer containing a PVA resin film having iodine or a dichroic dye adsorbed and having been oriented is obtained.

### Adhesive Layer

The optical film may be laminated to the polarizer through an adhesive layer as described above.

Examples of an adhesive constituting the adhesive layer include a PVA adhesive, an epoxy adhesive, an acrylic adhesive, and a polyolefin adhesive, such as a polyolefin grafted with an unsaturated carboxylic acid or an anhydride thereof and a mixture containing the grafted polyolefin. Examples thereof also include a transparent adhesive, for example, a polyvinyl ether adhesive and a rubber adhesive. Among these, a PVA adhesive is preferred.

The PVA adhesive contains a PVA resin and a crosslinking agent, and examples of the PVA resin include PVA obtained through saponification of polyvinyl acetate and a derivative thereof, a saponified product of a copolymer of vinyl acetate and a copolymerizable monomer, a modified PVA prepared through acetalization, urethanization, etherification, grafting, phosphatization or the like of PVA. The PVA resin may be used solely or in combination of two or more kinds thereof. Examples of the monomer copolymerizable with vinyl acetate include an unsaturated carboxylic acid and an ester thereof, such as maleic acid (or maleic anhydride), fumaric acid, crotonic acid, itaconic acid and (meth)acrylic acid; an α-olefin, such as ethylene and propylene; (meth) allylsulfonic acid (or a sodium salt thereof), sodium sulfonate (a monoalkylmaleate thereof), sodium disulfonate alkylmaleate, N-methylolacrylamide, an acrylamide alkylsulfonate alkali salt, N-vinylpyrrolidone and an N-vinylpyrrolidone derivative.

While the degree of polymerization or the like of the PVA resin are not particularly limited, the average degree of polymerization is generally approximately from 100 to 3,000, and preferably from 500 to 3,000, and the average degree of saponification is generally approximately from 85 to 100 mol %, and preferably approximately from 90 to 100 mol %, since good adhesiveness is obtained.

Examples of the epoxy adhesive include a hydrogenated epoxy resin, an alicyclic epoxy resin and an aliphatic epoxy resin. The epoxy resin may further contain a compound that promotes cationic polymerization, such as an oxetane compound and a polyol compound.

Particularly preferred examples of the acrylic adhesive include those containing, as a major component, a copolymer of an acrylate ester, such as butyl acrylate, ethyl acrylate, methyl acrylate and 2-ethylhexyl acrylate, and an α-monoolefin carboxylic acid, such as acrylic acid, maleic acid, itaconic acid, methacrylic acid and crotonic acid, (including those containing a vinyl monomer, such as acrylonitrile, vinyl acetate and styrene, added thereto) since they do not impair the polarizing characteristics of the polarizer.

A polyolefin having an unsaturated carboxylic acid or an anhydride thereof grafted therewith and a polyolefin having the grafted polyolefin mixed therewith may also be used as the adhesive. Examples of the polyolefin to be grafted include low density polyethylene, high density polyethylene, polypropylene, poly-1-butene, poly-4-methyl-1-pentene, an ethylene-propylene copolymer, an ethylene-1-butene copolymer, a propylene-1-butene copolymer and mixtures thereof. Examples of the unsaturated carboxylic acid and an anhydride thereof for grafting with the polyolefin include acrylic acid, methacrylic acid, maleic acid, maleic anhydride, citraconic acid, citraconic anhydride, itaconic acid and itaconic anhydride. The resulting modified polyolefin may be used as it is, or may be used after mixing with a polyolefin.

The adhesive layer may be formed by applying the adhesive to either one surface or both surfaces of the optical film or the polarizer. The thickness of the adhesive layer is preferably from 0.01 to 10 μm, and more preferably from 0.03 to 5 μm.

Upon laminating the optical film to the polarizer, the surface of the optical film that is in contact with the polarizer may be subjected to an adhesiveness-enhancing treatment for the purpose of enhancing the adhesiveness. Examples of the adhesiveness-enhancing treatment include a surface treatment, such as a corona treatment, a plasma treatment, a low pressure UV treatment and a saponification treatment, and a method of forming an anchor layer, which may be employed in combination. Among these, a corona treatment, a method of forming an anchor layer, and a combination thereof are preferred.

An adhesive layer is then formed on the surface having been subjected to the adhesiveness-enhancing treatment, and the optical film of the present invention is laminated to the polarizer through the adhesive layer. The lamination may be performed with a roll laminator or the like. The heating and drying temperature and the drying time may be appropriately determined depending on the kind of the adhesive.

The polarizer film of the present invention having a polarizer and the optical film of the present invention, which functions as a protective film for the polarizer laminated to at least one surface of the polarizer, may be laminated, on the other surface of the polarizer, with the optical film of the present invention or a film of another resin. Examples of the film of another resin include a fumaric diester resin, a cellulose triacetate film, a polyether sulfone film, a polyarylate film, a polyethyleneterephthalate film, a polynaphthalene terephthalate film, a polycarbonate film, a cyclic polyolefin film, a maleimide resin film and a fluorine resin film. The film of another resin may be a retardation film having a specific phase difference.

The polarizer film of the present invention is preferably a laminated product having at least one hardcoat layer for enhancing the surface property and the scratch resistance. Examples of the hardcoat layer include hardcoat layers containing a silicone resin, an acrylic resin, an acrylsilicone resin, an ultraviolet ray-curable resin and an urethane hardcoat agent, and among those, a hardcoat layer containing an ultraviolet ray-curable resin is preferred from the standpoint of transparency, scratch resistance and the chemical resistance. One or more of the hardcoat layers may be used.

Examples of the ultraviolet ray-curable resin include at least one selected from ultraviolet ray-curable acrylic urethane, ultraviolet ray-curable epoxy acrylate, ultraviolet ray-curable (poly)ester acrylate and ultraviolet ray-curable oxetane.

The thickness of the hardcoat layer is preferably from 0.1 to 100 more preferably from 1 to 50 μm, and further preferably from 2 to 20 μm. A primer treatment may be performed under the hardcoat layer.

The polarizer film of the present invention may be subjected to a known antiglare treatment, such as antireflection and reflection reduction treatments.

### Image Display Device

The polarizer film having the optical film of the present invention formed on at least one surface thereof may be used by laminating, for example, with a liquid crystal cell. FIG. 2 shows a constitutional example of a liquid crystal cell having the optical film and a polarizer film of the present invention. In FIG. 2, numeral 6 denotes a liquid crystal cell. Examples of the liquid crystal cell 6 include an active matrix driving cell, such as a thin film transistor type, and a simple matrix driving cell, such as a twisted nematic mode type and a super-twisted nematic type. The constitutional example of the liquid crystal cell in FIG. 2 contains, on the liquid crystal cell 6, a retardation film 8 laminated thereon through an adhesive layer (which is not shown in the figure, the same applied hereinafter) and the polarizer film 7 of the present invention further laminated thereon through an adhesive layer (which is not shown in the figure). The optical device 2 contains the retardation film 8 and the polarizer film 7 laminated on each other, and the polarizer film 7 has a polarizer 3 at the center thereof and has a protective film 4 formed of the optical film of the present invention laminated on each of both surfaces thereof through an adhesive layer 5. Upon laminating the polarizer film 7 of the present invention and the retardation film 8, and laminating the retardation film 8 and the liquid crystal cell 6, an adhesive layer may be provided in advance on the polarizer film 7, the retardation film 8 and the liquid crystal cell 6.

The adhesive for laminating the polarizer film of the present invention and the liquid crystal cell is not particularly limited, and for example, an adhesive containing a base polymer appropriately selected from polymers, such as an acrylic polymer, a silicone polymer, polyester, polyurethane, polyamide, polyether, a fluorine polymer, a rubber polymer and the like may be used. Among these, an acrylic adhesive is preferred since it is excellent in optical transparency, exhibits suitable adhesive characteristics including wettability, cohesiveness and adhesiveness, and is excellent in weather resistance and heat resistance.

The adhesive is demanded to be excellent in optical transparency, to have suitable adhesive characteristics including wettability, cohesiveness and adhesiveness, and to be excellent in weather resistance and heat resistance. Furthermore, such an adhesive layer is demanded that has low moisture absorbability and excellent heat resistance from the standpoint of preventing a foaming phenomenon and a peeling phenomenon caused by moisture absorption, preventing deterioration in optical characteristics of and deformation of the liquid crystal cell due to differences in thermal expansion or the like, and securing formation of an image display device with high quality and excellent durability.

The adhesive may contain a natural or synthetic resin, particularly an adhesiveness-imparting resin, a filler containing glass fibers, glass beads, metal powder, other inorganic powder or the like, and an additive, such as a pigment, a colorant and an antioxidant. An adhesive layer exhibiting light diffusion property by containing fine particles may be used.

The coating method of the adhesive to the polarizer film of the present invention is not particularly limited, and an appropriate method may be employed. Examples of the method include a method of dissolving or dispersing the base polymer or a composition thereof in a single material or a mixed material of suitable solvents, such as toluene and ethyl acetate, to prepare an adhesive solution of approximately from 10 to 40% by mass, and applying the solution directly onto the polarizer film of the present invention by a suitable spreading method, such as a casting method and a coating method, and a method of forming an adhesive layer on a releasable base film according to the aforementioned method and transferring it onto the polarizer film of the present invention.

Examples of the coating method include various methods, such as gravure coating, bar coating, roll coating, reverse roll coating and comma coating, and gravure coating is most ordinarily employed.

The adhesive layer may have a multilayer structure of different compositions or kinds, which may be formed on one or both surfaces of the polarizer film of the present invention. In the case where the layers are formed on both surfaces of the polarizer film of the present invention, the adhesives may not have the same composition and may not have the same thickness on both the front surface and the back of the polarizer film. Adhesive layers having different compositions or different thicknesses may be provided.

The thickness of the adhesive layer may be appropriately determined depending on the purpose and the adhesive power, and is generally from 1 to 500 μm, preferably from 5 to 200 μm, and more preferably from 10 to 100 μm.

The exposed surface of the adhesive layer is preferably covered by temporarily attaching thereto a release film for the purpose of preventing the surface from being contaminated before use in practice. According to the procedure, the adhesive layer may be protected from contact in the ordinary handling conditions. The release film may be any known one, and example thereof include a thin sheet material, such as plastic film, a rubber sheet, paper, a woven fabric, a nonwoven fabric, a net, a foamed sheet, a metallic foil and laminated product thereof, which may be coated with a suitable releasing agent of a silicone series, long-chain alkyl series, a fluorine series, a molybdenum sulfide series or the like depending on necessity.

In the present invention, the polarizer and the layers including the protective film layer and the adhesive layer may be imparted with ultraviolet ray absorbing capability by subjecting to a treatment with an ultraviolet ray absorbent, such as a salicylate ester compound, a benzophenol compound, a benzotriazole compound, a cyanoacrylate compound, a nickel complex compounds or the like.

The polarizer film of the present invention is favorably used for producing various devices, such as an image display devices. Examples of the image display device include a liquid crystal display device containing a liquid crystal cell, an organic EL display device and a touch-sensitive panel, and the image display device is not limited in kind as far as it uses a polarizer film. In the case of a liquid crystal display, the image display device is generally produced by suitably assembling constitutive components including a liquid crystal cell, an optical film and optionally an illumination system, to which a driving circuit is incorporated. In the present invention, however, the constitution of the image display device is not particularly limited except that the aforementioned polarizer film is employed. Examples of the device include an image display device having the polarizer film on one surface or both surfaces of a liquid crystal cell, and one having a backlight or a reflection plate as an illumination system. The liquid crystal cell may be a known one including a TN type, an STN type and a π type. Upon constructing the image display device, for example, one layer or two or more layers of suitable components, such as a diffuser plate, an antiglare layer, an antireflection film, a protective plate, a prism array, a lens array sheet, a light diffusing plate and a backlight, may be disposed at suitable positions.

### Application to Organic EL Display Device

The polarizer film of the present invention may be favorably applied to an organic EL display device.

In general, an organic EL display device contains a light emitter (i.e., an organic electroluminescent emitter) formed by laminating a transparent electrode, an organic light emission layer and a metal electrode in this order on a transparent substrate. The organic light emission layer herein is a laminated product of various organic thin films, and structures with various combinations have been known therefor, examples of which include a laminated product of a hole injection layer containing a triphenylamine derivative or the like and a light emission layer containing a fluorescent organic solid, such as anthracene; a laminated product of the light emission layer and an electron injection layer containing a perylene derivative or the like; and a laminated product containing the hole injection layer, the light emission layer and the electron injection layer.

The organic EL display devices emits light according to such a principle that holes and electrons are injected into the organic light emission layer through voltage application to the transparent electrode and the metal electrode, thereby exciting the fluorescent substance with the energy generated through recombination of the holes and the electrons, and the excited fluorescent substance radiates light upon restoring to the ground state. The mechanism of recombination in the course of the process is the same as that in an ordinary diode, and as will be estimated from the process, the electric current and the light emission intensity exhibit strong nonlinearity accompanied with rectification relative to the applied voltage.

In the organic EL display device, at least one electrode is necessarily transparent for taking out light emitted by the organic light emission layer, and therefore, a transparent electrode formed of a transparent electroconductor, such as indium tin oxide (ITO), is generally used as an anode. For facilitating the electron injection to enhance the light emission efficiency, on the other hand, it is important to use a substance having a small work function as a cathode, and in general, a metal electrode, such as Mg—Ag and Al—Li, is used therefor.

In the organic EL display device having the aforementioned structure, the organic light emission layer is formed of an extremely thin film having a thickness of approximately 10 nm. Accordingly, the organic light emission layer completely transmits light therethrough as similar to the transparent electrode. As a result, in the absence of light emission from the device, light that is incident on the surface of the transparent substrate, and then reflected on the metal electrode after being transmitted through the transparent electrode and the organic light emission layer is again emitted toward the side of the surface of the transparent substrate, and therefore, the display surface of the organic EL display device seen from the outside looks like a mirror surface.

In the organic EL display device containing a transparent electrode on the front surface side of the organic light emission layer emitting light through voltage application and containing an organic electroluminescent light emitter equipped with a metal electrode on the back surface side of the organic light emission layer, a polarizer film of the present invention may be provided on the front surface side of the transparent electrode, and a birefringence layer (retardation film) may be provided between the transparent electrode and the polarizer film.

The polarizer film of the present invention has a function of polarizing light that is externally incident and reflected on a metal electrode, and therefore has a function of preventing the mirror surface of the metal electrode from being viewed, owing to the polarizing function thereof. In particular, in the case where the birefringence layer is constituted by a λ/4 plate and the angle between the polarizing directions of the polarizer film and the birefringence layer is controlled to π/4, the mirror surface of the metal electrode can be completely concealed.

Specifically, only the linearly polarized component of the light that is externally incident on the organic EL display device is transmitted owing to the polarizer film. The linearly polarized light generally becomes elliptically polarized light with the birefringence layer, but in the case where the birefringence layer is a λ/4 plate and the angle formed with the polarizing directions of the polarizer film is π/4, circularly polarized light is obtained. The circularly polarized light is transmitted through the transparent substrate, the transparent electrode and the organic thin film, then reflected on the metal electrode and again transmitted through the organic thin film, the transparent electrode and the transparent substrate, thereby again forming linearly polarized light at the birefringence layer. The linearly polarized light is perpendicular to the polarization direction of the polarizer film and thus is not transmitted through the polarizer film. As a result, the mirror surface of the metal electrode can be completely concealed.

### Application to Touch-sensitive Panel

The optical film of the present invention can be favorably applied as a polarizer film for a touch-sensitive panel. In general, a touch-sensitive panel is such a device that an operator touches a transparent surface provided on the top of the display panel thereof with a pen or a finger to operate the device and the system. The direct touch on the panel surface is more direct and more intuitive as compared to an operation determining a position with a cursor by pushing direction keys, and has become often employed in recent years. Furthermore, owing to the remarkable growth of a mobile terminal market including a mobile phone and a PDA (personal digital assistant) in recent years, the devices are strongly demanded to be visible under sunlight and to be thin and lightweight. Various types of touch-sensitive panels are known and are differentiated for the use depending on the advantages and disadvantages thereof. Examples of the touch-sensitive panel include a resistance film type, an optical type, a capacitance coupling type (which may also be referred to as an analogue capacitive coupling type), an infrared ray type, an ultrasonic type and an electromagnetic conduction type. As an example, a resistance film type touch-sensitive panel will be described below.

A resistance-film type touch-sensitive panel includes a glass-glass type and a glass-film type. The glass-glass type contains a glass substrate having a transparent electroconductive layer and another glass substrate having a transparent electroconductive layer, which are held with a space between them, and the assembly is attached to the surface of the display. The glass-film type is for a vehicle-mounted or portable touch-sensitive panel and is demanded to have a lighter weight and a thinner profile, in which the upper glass substrate having a transparent electroconductive layer is replaced by an optical film.

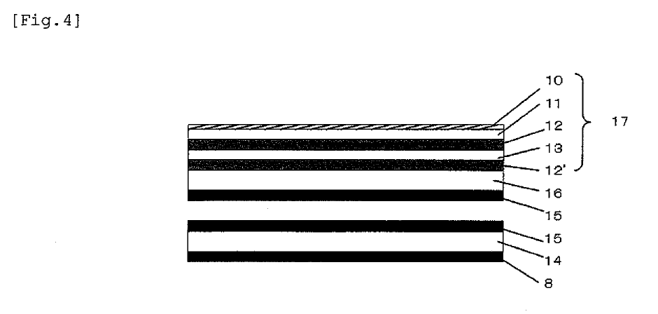

FIG. 3 shows a glass-glass type touch-sensitive panel, and FIG. 4 shows a glass-film type touch-sensitive panel. The glass-glass type touch-sensitive panel and the glass-film type touch-sensitive panel will be described below with reference to FIGS. 3 and 4.

A linear polarizer film or a circular polarizer film containing a combination of a polarizer film and a λ/4 plate laminated thereon may be used at the outermost surface of a touch-sensitive panel, whereby the touch-sensitive panel may have a sufficient strength, and the visibility is enhanced owing to the effect of antireflection. The polarizer film in the touch-sensitive panel is denoted by numeral 9 in FIG. 3 or 17 in FIG. 4. The optical film of the present invention can be favorably used as the polarizer film in these touch-sensitive panels.

A circular polarizer film can be obtained by laminating a polarizer film containing the optical film of the present invention and a polarizer, and a λ/4 plate in such a manner that the angle between the in-plane slow axis of the λ/4 plate and the polarization axis of the polarizer film is substantially 45°. The term substantially 45° means that the angle is from 40 to 50°. The angle between the in-plane slow axis of the λ/4 plate and the polarization axis of the polarizer film is preferably from 41 to 49°, more preferably from 42 to 48°, further preferably from 43 to 47°, and most preferably from 44 to 46°.

The optical film of the present invention may be used as any of the upper or lower protective film or the lower outer protective film (the film for weight reduction provided with ITO) of the polarizer film. For antireflection of touch panels, a linear polarization type and a circular polarization type may be used (the linear polarization type has a higher refractive index than the circular polarization type), and the optical film of the present invention may be used in any of the circular polarization type and linear polarization type polarizer films.

The circular polarizer film and the linear polarizer film containing the optical film of the present invention may be used for any of transmission type and reflection type touch-sensitive panels.

### Example

The present invention will be described in more detail with reference to the following Examples and Comparative Examples, but the present invention is not limited by the Examples.

### Evaluation Methods

### 1. Bending Elastic Modulus

It was measured according to JIS K7171.

### 2. Measurement of MFR

It was measured with Melt Indexer (F-W01 (model number), produced by Toyo Seiki Seisaku-Sho, Ltd.) according to JIS K7210 under conditions of 230° C. and a load of 2.16 kg.

### 3. Evaluation of In-plane Phase Difference

The in-plane phase difference was measured with a phase difference meter (“KOBRA-WR” (model number), produced by Oji Scientific Instruments, Ltd.) at a wavelength of 589.3 nm and at an incident angle of 0°.

### 4. Transparency (Haze)

It was measured according to JIS K7105.

### 5. Evaluation of Ultraviolet Ray Absorbing Capability

The light transmittance was measured at wavelengths of 250 nm (UV-C range), 310 nm (UV-B range), and 330 nm and 370 nm (UV-A range) with an ultraviolet-visible spectrophotometer (“UV-2400” (model number), produced by Shimadzu Corporation).

AA: transmittance of 0% or more and less than 10%
A: transmittance of 10% or more and less than 20%
B: transmittance of 20% or more and less than 30%
C: transmittance of 30% or more

### 6. Evaluation of Visible Light Transmittance

The light transmittance was measured at wavelengths of 550 nm and 750 nm with an ultraviolet-visible spectrophotometer (“UV-2400” (model number), produced by Shimadzu Corporation).

AA: transmittance of from 90 to 100%
A: transmittance of from 80 to 90%
C: transmittance of less than 80%

### 7. Evaluation of Bleeding (Oozing) of Ultraviolet Ray Absorbent 1

The optical films obtained in Examples 1 to 5 and Comparative Example 1 to 4 were placed at room temperature for one week after the production of the films, and the appearance (presence of bleeding of the ultraviolet ray absorbent) of the films was visually evaluated by the following standard.

A: completely no bleeding (oozing)
B: whitening observed partially due to bleeding (oozing) with no practical problem
C: whitening observed totally due to bleeding (oozing)

### 8. Evaluation of Bleeding (Oozing) of Ultraviolet Ray Absorbent 2

The optical films obtained in Examples 6 to 13 and Comparative Example 5 and 6 were placed under the following two conditions for 1,000 hours after the production of the films, and the appearance (presence of bleeding of the ultraviolet ray absorbent) of the films was visually evaluated by the following standard.

### Conditions

Condition 1: 80° C. dry

Condition 2: 60° C., 90% RH

A: completely no bleeding (oozing)
B: whitening observed partially due to bleeding (oozing) with no practical problem
C: whitening observed totally due to bleeding (oozing)

### Example 1

A benzotriazole phenol compound (2-(2H-benzotriazol-2-yl)-4,6-bis(1-methyl-1-phenylethyl)-phenol, “Tinuvin 234” (trade name), produced by Ciba Specialty Chemicals Co., Ltd.) as an ultraviolet ray absorbent was added to a polypropylene resin synthesized with a metallocene catalyst (“Wintec” (trade name), produced by Japan Polypropylene Corporation, bending elastic modulus: 900 MPa, melting point: 142° C., hereinafter referred to as “mPP-A”) to prepare a polypropylene resin mixture. The content of the benzotriazole phenol compound herein was 1.0% by mass based on the polypropylene resin mixture. The polypropylene resin mixture was formed into an optical film by T-die extrusion to a thickness of 100 μm at a processing temperature of 200° C. and at a take-up roll temperature of 50° C. The optical film was evaluated according to the aforementioned evaluation methods. The results are shown in Tables 1 and 2.

### Example 2

An optical film was obtained in the same manner as in Example 1 except that the content of the benzotriazole phenol compound was changed to 0.5% by mass based on the polypropylene resin mixture. The results of evaluation in the same manner as in Example 1 are shown in Tables 1 and 2.

### Example 3

An optical film was obtained in the same manner as in Example 1 except that the content of the benzotriazole phenol compound was changed to 5% by mass based on the polypropylene resin mixture. The results of evaluation in the same manner as in Example 1 are shown in Tables 1 and 2.

### Example 4

An optical film was obtained in the same manner as in Example 1 except that in addition to the polypropylene resin and the benzotriazole phenol compound, a di-substituted dibenzylidene sorbitol additive (1,3-2,4-di-p-methylbenzylidene sorbitol, “Irgaclear DM” (trade name), produced by Ciba Specialty Chemicals Co., Ltd.) was further added thereto to prepare a polyester resin mixture, and the content of the di-substituted dibenzylidene sorbitol additive was 0.1% by mass based on the polyester resin mixture. The results of evaluation in the same manner as in Example 1 are shown in Tables 1 and 2.

### Example 5

An optical film was obtained in the same manner as in Example 1 except that a polypropylene resin synthesized with a metallocene catalyst (“Wintec” (trade name), produced by Japan Polypropylene Corporation, bending elastic modulus: 700 MPa, melting point: 125° C., hereinafter referred to as “mPP-B”) was used instead of mPP-A. The results of evaluation in the same manner as in Example 1 are shown in Tables 1 and 2.

### Examples 6 to 10

Optical films were obtained in the same manner as in Example 1 except that the ultraviolet ray absorbent was changed to a benzotriazole phenol compound (2-(2H-benzotriazol-2-yl)-4-(1,1,3,3-tetramethylbutyl)-phenol, “Tinuvin 329” (trade name), produced by Ciba Specialty Chemicals Co., Ltd.) and the content thereof shown in Table 3 was used. The results of evaluation in the same manner as in Example 1 are shown in Tables 3 and 4.

### Example 11

An optical film was obtained in the same manner as in Example 4 except that the ultraviolet ray absorbent was changed to a benzotriazole phenol compound (2-(2H-benzotriazol-2-yl)-4-(1,1,3,3-tetramethylbutyl)-phenol, “Tinuvin 329” (trade name), produced by Ciba Specialty Chemicals Co., Ltd.). The results of evaluation in the same manner as in Example 4 are shown in Tables 3 and 4.

### Example 12

An optical film was obtained in the same manner as in Example 6 except that a polypropylene resin synthesized with a metallocene catalyst (“Wintec” (trade name), produced by Japan Polypropylene Corporation, bending elastic modulus: 700 MPa, melting point: 125° C., hereinafter referred to as “mPP-B”) was used instead of mPP-A. The results of evaluation in the same manner as in Example 6 are shown in Tables 1 and 2.

### Example 13

An optical film was obtained in the same manner as in Example 1 except that the ultraviolet ray absorbent was changed to a benzotriazole phenol compound (2-(2H-benzotriazol-2-yl)-4,6-di-tert-pentylphenol, “Tinuvin 328” (trade name), produced by Ciba Specialty Chemicals Co., Ltd.). The results of evaluation in the same manner as in Example 1 are shown in Tables 3 and 4.

### Comparative Example 1

An optical film was obtained in the same manner as in Example 1 except that the content of the benzotriazole phenol compound was changed to 0.03% by mass. The results of evaluation in the same manner as in Example 1 are shown in Tables 1 and 2.

### Comparative Example 2

An optical film was obtained in the same manner as in Example 1 except that the content of the benzotriazole phenol compound was changed to 6% by mass. The results of evaluation in the same manner as in Example 1 are shown in Tables 1 and 2.

### Comparative Example 3

An optical film was obtained in the same manner as in Example 1 except that the benzotriazole phenol compound was changed to a benzophenone compound (octabenzone, “Chimassorb 81” (trade name), produced by Ciba Specialty Chemicals Co., Ltd.). The results of evaluation in the same manner as in Example 1 are shown in Tables 1 and 2.

### Comparative Example 4

An optical film was obtained in the same manner as in Example 1 except that the benzotriazole phenol compound was changed to a triazine compound (2-(4,6-diphenyl-1,3,5-triazin-2-yl)-5-((hexyl)oxy)phenol, “Tinuvin 1577FF” (trade name), produced by Ciba Specialty Chemicals Co., Ltd.). The results of evaluation in the same manner as in Example 1 are shown in Tables 1 and 2.

### Comparative Examples 5 and 6

Optical films were obtained in the same manner as in Example 6 except that the content of the benzotriazole phenol compound was changed to the amounts shown in Table 3. The results of evaluation in the same manner as in Example 6 are shown in Tables 3 and 4.

TABLE 1

| | | | Content of | | | | | |
|---|---|---|---|---|---|---|---|---|
| | | | ultraviolet | Content of | Bending | | In-plane | |
| | | | ray | sorbitol | elastic | MFR | phase | Transparency |
| | Polypropylene | Ultraviolet | absorbent | additive | modulus | (g per 10 | difference | haze |
| | resin | ray absorbent | (% by mass) | (% by mass) | (MPa) | minutes) | (nm) | (%) |
| Example 1 | mPP-A | Tinuvin 234 | 1.0 | — | 900 | 24 | 5 | 5 |
| Example 2 | mPP-A | Tinuvin 234 | 0.1 | — | 900 | 24 | 4 | 5 |
| Example 3 | mPP-A | Tinuvin 234 | 5.0 | — | 900 | 24 | 5 | 5 |
| Example 4 | mPP-A | Tinuvin 234 | 1.0 | 0.1 | 900 | 24 | 7 | 3 |
| Example 5 | mPP-B | Tinuvin 234 | 1.0 | — | 700 | 15 | 4 to 30 *1 | 5 |
| Comparative | mPP-A | Tinuvin 234 | 0.03 | — | 900 | 24 | 5 | 5 |
| Example 1 | | | | | | | | |
| Comparative | mPP-A | Tinuvin 234 | 6.0 | — | 900 | 24 | 5 | 5 |
| Example 2 | | | | | | | | |
| Comparative | mPP-A | Chimassorb 81 | 1.0 | — | 900 | 24 | 6 | 5 |
| Example 3 | | | | | | | | |
| Comparative | mPP-A | Tinuvin 1577FF | 1.0 | — | 900 | 24 | 9 | 5 |
| Example 4 | | | | | | | | |

*1 The in-plane phase difference was fluctuated in the production method disclosed in Example due to the stress applied to the edges of the film, but the in-plane phase difference was low, and thus the films were able to be used as a polarizer film within a certain lot.

TABLE 2

| | Ultraviolet ray absorbing capability | | | | | | |
|---|---|---|---|---|---|---|---|
| | UV-C | UV-B | UV-A | | Visible light transmittance | | |
| | 250 nm | 310 nm | 330 nm | 370 nm | 550 nm | 750 nm | |
| | upper line: (%) | upper line: (%) | upper line: (%) | upper line: (%) | upper line: (%) | upper line: (%) | |
| | lower line: | lower line: | lower line: | lower line: | lower line: | lower line: | Evaluation |
| | evaluation | evaluation | evaluation | evaluation | evaluation | evaluation | of bleeding |
| Example 1 | 9.0 | 0.2 | 0.2 | 1.3 | 91.2 | 92.2 | A |
| | AA | AA | AA | AA | AA | AA | |
| Example 2 | 18.2 | 1.1 | 1.8 | 11.1 | 90.2 | 90.8 | A |
| | A | AA | AA | A | AA | AA | |
| Example 3 | 7.0 | 0.1 | 0.1 | 1.0 | 90.2 | 91.0 | B |
| | AA | AA | AA | AA | AA | AA | |
| Example 4 | 3.3 | 0.3 | 0.6 | 1.6 | 92.2 | 92.9 | A |
| | AA | AA | AA | AA | AA | AA | |
| Example 5 | 2.0 | 0.2 | 0.2 | 1.4 | 91.0 | 92.7 | A |
| | AA | AA | AA | AA | AA | AA | |
| Comparative | 30.1 | 8.5 | 9.5 | 31.4 | 90.5 | 91.5 | A |
| Example 1 | C | AA | AA | C | AA | AA | |
| Comparative | 5.0 | 0.1 | 0.1 | 0.3 | 92.1 | 91.8 | C |
| Example 2 | AA | AA | AA | AA | AA | AA | |
| Comparative | 0.1 | 0.6 | 0.2 | 48.5 | 91.2 | 92.2 | C |
| Example 3 | AA | AA | AA | C | AA | AA | |
| Comparative | 0.1 | 0.1 | 0.1 | 3.5 | 92.4 | 92.9 | C |
| Example 4 | AA | AA | AA | AA | AA | AA | |

TABLE 3

| | | | Content of | Content of | Bending | | In-plane | |
|---|---|---|---|---|---|---|---|---|
| | | | ultraviolet | sorbitol | elastic | MFR | phase | Transparency |
| | Polypropylene | Ultraviolet | ray absorbent | additive | modulus | (g per 10 | difference | haze |
| | resin | ray absorbent | (% by mass) | (% by mass) | (MPa) | minutes) | (nm) | (%) |
| Example 6 | mPP-A | Tinuvin 329 | 1.0 | — | 900 | 24 | 5 | 5 |
| Example 7 | mPP-A | Tinuvin 329 | 0.5 | — | 900 | 24 | 5 | 5 |
| Example 8 | mPP-A | Tinuvin 329 | 0.25 | — | 900 | 24 | 5 | 5 |
| Example 9 | mPP-A | Tinuvin 329 | 0.1 | — | 900 | 24 | 4 | 5 |
| Example 10 | mPP-A | Tinuvin 329 | 5.0 | — | 900 | 24 | 5 | 5 |
| Example 11 | mPP-A | Tinuvin 329 | 1.0 | 0.1 | 900 | 24 | 7 | 3 |
| Example 12 | mPP-B | Tinuvin 329 | 1.0 | — | 700 | 15 | 4 to 30 *1 | 5 |
| Example 13 | mPP-A | Tinuvin 328 | 1.0 | — | 900 | 24 | 5 | 5 |
| Comparative | mPP-A | Tinuvin 329 | 0.03 | — | 900 | 24 | 5 | 5 |
| Example 5 | | | | | | | | |
| Comparative | mPP-A | Tinuvin 329 | 6.0 | — | 900 | 24 | 5 | 5 |
| Example 6 | | | | | | | | |

*1 The in-plane phase difference was fluctuated in the production method disclosed in Example due to the stress applied to the edges of the film, but the in-plane phase difference was low, and thus the films were able to be used as a polarizer film within a certain lot.

TABLE 4

| | Ultraviolet ray absorbing capability | | | | | | | |
|---|---|---|---|---|---|---|---|---|
| | UV-C | UV-B | UV-A | | Visible light transmittance | | | |
| | 250 nm | 310 nm | 330 nm | 370 nm | 550 nm | 750 nm | Evaluation of | |
| | upper line: (%) | upper line: (%) | upper line: (%) | upper line: (%) | upper line: (%) | upper line: (%) | bleeding | |
| | lower line: | lower line: | lower line: | lower line: | lower line: | lower line: | Condition | Condition |
| | evaluation | evaluation | evaluation | evaluation | evaluation | evaluation | 1 | 2 |
| Example 6 | 0.7 | 0.1 | 0.1 | 0.8 | 92.3 | 92.5 | A | A |
| | AA | AA | AA | AA | AA | AA | | |
| Example 7 | 8.1 | 1.9 | 1.6 | 8.3 | 92.2 | 92.4 | A | A |
| | AA | AA | AA | AA | AA | AA | | |
| Example 8 | 26.0 | 12.2 | 13.5 | 25.0 | 92.7 | 93.2 | A | A |
| | B | A | A | B | AA | AA | | |
| Example 9 | 29.5 | 15.5 | 15.1 | 29.2 | 92.8 | 92.6 | A | A |
| | B | A | A | B | AA | AA | | |
| Example 10 | 0.5 | 0.1 | 0.1 | 0.7 | 91.2 | 92.0 | B | B |
| | AA | AA | AA | AA | AA | AA | | |
| Example 11 | 0.7 | 0.2 | 0.1 | 1.0 | 92.0 | 92.7 | A | A |
| | AA | AA | AA | AA | AA | AA | | |
| Example 12 | 1.8 | 0.1 | 0.2 | 1.4 | 91.2 | 92.0 | A | A |
| | AA | AA | AA | AA | AA | AA | | |
| Example 13 | 3.1 | 0.1 | 0.1 | 0.6 | 92.4 | 93.4 | A | A |
| | AA | AA | AA | AA | AA | AA | | |
| Comparative | 33.5 | 18.5 | 20.5 | 33.4 | 92.4 | 92.6 | A | A |
| Example 5 | C | A | B | C | AA | AA | | |
| Comparative | 0.6 | 0.1 | 0.1 | 0.6 | 91.1 | 91.0 | C | C |
| Example 6 | AA | AA | AA | AA | AA | AA | | |

### INDUSTRIAL APPLICABILITY

According to the present invention, such an optical film can be provided that has excellent optical characteristics, such as small haze, excellent transparency, high visible light transmittance and low birefringence, is excellent in water vapor transmission rate, and has excellent ultraviolet ray absorbing capability. The optical film of the present invention is excellent in various durability, such as heat resistance and wet heat resistance, may enhance the polarization degree of a polarizer film without influence on the optical function of the polarizer film, and is flexible and rich in elasticity.

Furthermore, the optical film of the present invention has resistance to external impact and deformation and has favorable ultraviolet ray absorbing capability, and therefore, by laminating the optical film to a polarizer, such a polarizer film is provided that is capable of significantly enhancing the strength and the reliability of a liquid crystal display device.

Moreover, as compared to a TAC film having been generally used, while a TAC film is hydrophilic and has little moisture blocking property, the optical film of the present invention is hydrophobic and thus can greatly enhance durability of a polarizer film. Accordingly, the optical film of the present invention can be favorably used as a protective film that is laminated on at least one surface of the polarizer film and is also adhered to the surface of the substrate of the liquid crystal cell, and can also be used as a protective film on the other side of the polarizer film.

1. An optical film for a protective film for a polarizer, comprising a polypropylene resin mixture containing, as a major component, a polypropylene resin synthesized with a metallocene catalyst, having a benzotriazole compound added thereto, a content of the benzotriazole compound being from 0.08 to 5.5% by mass based on the polypropylene resin mixture.

2. The optical film according to claim 1, wherein the polypropylene resin has a bending elastic modulus of 700 MPa or more.

3. The optical film according to claim 1, wherein the polypropylene resin has a melt flow rate (MFR: measured under conditions of 230° C. and a load of 2.16 kg according to JIS K7210) of 20 g per 10 minutes or more.

4. The optical film according to claim 1, wherein the benzotriazole compound is a benzotriazole phenol compound.

5. The optical film according to claim 4, wherein the benzotriazole phenol compound is 2-(2H-benzotriazol-2-yl)-4-(1,1,3,3-tetramethylbutyl)phenol or 2-(2H-benzotriazol-2-yl)-4,6-di-tert-pentylphenol.

6. The optical film according to claim 1, wherein the optical film is an unstretched film.

7. A polarizer film comprising the optical film according to claim 1 provided on at least one surface of a polarizer.

8. The polarizer film according to claim 7, wherein the polarizer film is used by adhering to a liquid crystal cell, and the optical film is provided on a side of the polarizer opposite to the liquid crystal cell.

9. An image display device comprising the polarizer film according to claim 7.
